(19) United States
(12) Patent Application Publication
(10) Pub. No.: US 2026/0061820 A1
(43) Pub. Date: Mar. 5, 2026

(54) PICKUP TRUCK

(71) Applicant: TOYOTA JIDOSHA KABUSHIKI KAISHA, Toyota-shi Aichi-ken (JP)

(72) Inventors: Michio YOSHIDA, Susono-shi (JP); Tomoaki YANAGIDA, Susono-shi (JP); Taku SEGAWA, Numazu-shi (JP); Yoshiteru INAMOTO, Toyota-shi (JP); Takumi JINMON, Ann Arbor, MI (US); Taesoo KIM, Ann Arbor, MI (US); Jason CREMER, Stockbridge, MI (US); Juan VELASCO, Ypsilanti, MI (US); Takehito YODA, Novi, MI (US); David NAKAYAMA, Canton, MI (US); Ryan HARRIS, Saline, MI (US)

(73) Assignee: TOYOTA JIDOSHA KABUSHIKI KAISHA, Toyota-shi Aichi-ken (JP)

(21) Appl. No.: 19/310,021

(22) Filed: Aug. 26, 2025

(30) Foreign Application Priority Data
Aug. 29, 2024 (JP) 2024-147281

(51) Int. Cl. B60K 1/04

(52) U.S. Cl. CPC B60K 1/04; B60K 2001/0416; B60K 2001/0433

(57) ABSTRACT

A pickup truck is configured as a plug-in hybrid electric vehicle. The pickup truck includes a cabin section provided with a passenger compartment; an engine compartment section, and a cargo section. The engine compartment section includes an engine compartment in which an engine is arranged longitudinally. The cargo section includes a truck bed that opens upward. The pickup truck further includes a main battery as a power source for a motor. The main battery is installed in a region in the cargo section that is below a floor panel of the truck bed and above a frame.

### CROSS-REFERENCE TO RELATED APPLICATIONS

This application is based upon and claims the benefit of priority from Japanese Patent Application No. 2024-147281, filed on Aug. 29, 2024, the entire contents of which are incorporated herein by reference.

### BACKGROUND

### 1. Field

The present disclosure relates to a pickup truck configured as a plug-in hybrid electric vehicle.

### 2. Description of Related Art

Japanese Laid-Open Patent Publication No. 2022-085506 discloses a hybrid electric vehicle that includes a longitudinally mounted engine and a battery disposed in an area surrounding the propeller shaft located beneath the vehicle floor.

A plug-in hybrid electric vehicle (hereinafter referred to as a PHEV) is configured to be externally rechargeable and includes a large-capacity battery in addition to two drive sources; namely, an engine and a motor. One known vehicle type is a pickup truck. A pickup truck includes a truck bed, which is rearward of the cabin and opens upward. Many pickup trucks include a body having a frame structure. A variety of components, including a transmission, a propeller shaft, an exhaust pipe, and a fuel tank, are disposed beneath the floor of the passenger compartment of a pickup truck.

There is a demand for pickup trucks that allow space to be provided beneath the passenger compartment floor.

### SUMMARY

This Summary is provided to introduce a selection of concepts in a simplified form that are further described below in the Detailed Description. This Summary is not intended to identify key features of the claimed subject matter, nor is it intended to be used as an aid in determining the scope of the claimed subject matter.

In one general aspect, a pickup truck configured as a plug-in hybrid electric vehicle includes a fuel tank, an engine, a motor, a transmission, a propeller shaft connected to the engine via the motor and the transmission and configured to transmit rotational driving force of the engine and the motor to a rear wheel, an exhaust pipe that guides exhaust gas of the engine rearward in the vehicle, a cabin section provided with a passenger compartment, an engine compartment section forward of the cabin section, a cargo section rearward of the cabin section, and a frame including left and right side members that extend in a vehicle longitudinal direction through a region in the cabin section that is below the passenger compartment. The engine compartment section includes an engine compartment in which the engine is arranged longitudinally. The cargo section includes a truck bed that opens upward. The propeller shaft and the exhaust pipe extend in the vehicle longitudinal direction through the region in the cabin section that is below the passenger compartment. The pickup truck further comprises a main battery as a power source for the motor. The main battery is installed in a region in the cargo section that is below a floor panel of the truck bed.

Other features and aspects will be apparent from the following detailed description, the drawings, and the claims.

### BRIEF DESCRIPTION OF THE DRAWINGS

FIG. 1 is a side view illustrating the arrangement of components in a pickup truck according to a first embodiment.

FIG. 2 is a top view illustrating the arrangement of components such as a drivetrain, a frame, an exhaust pipe, and a fuel tank of the pickup truck shown in FIG. 1.

FIG. 3 is a side view illustrating the arrangement of components such as a main battery in the pickup truck shown in FIG. 1.

FIG. 4 is a top view illustrating the arrangement of components such as the main battery in the pickup truck shown in FIG. 1.

FIG. 5 is a plan view illustrating the arrangement of components such as a main battery in a pickup truck according to a second embodiment.

FIG. 6 is a side view illustrating the arrangement of components such as the main battery in the pickup truck shown in FIG. 5.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

In general, when plug-in hybrid equipment is installed in a pickup truck, sufficient space for mounting a battery may not be available beneath the floor of the passenger compartment.

Each embodiment of the present disclosure provides a pickup truck-type PHEV configured to provide a sufficient battery mounting space.

### First Embodiment

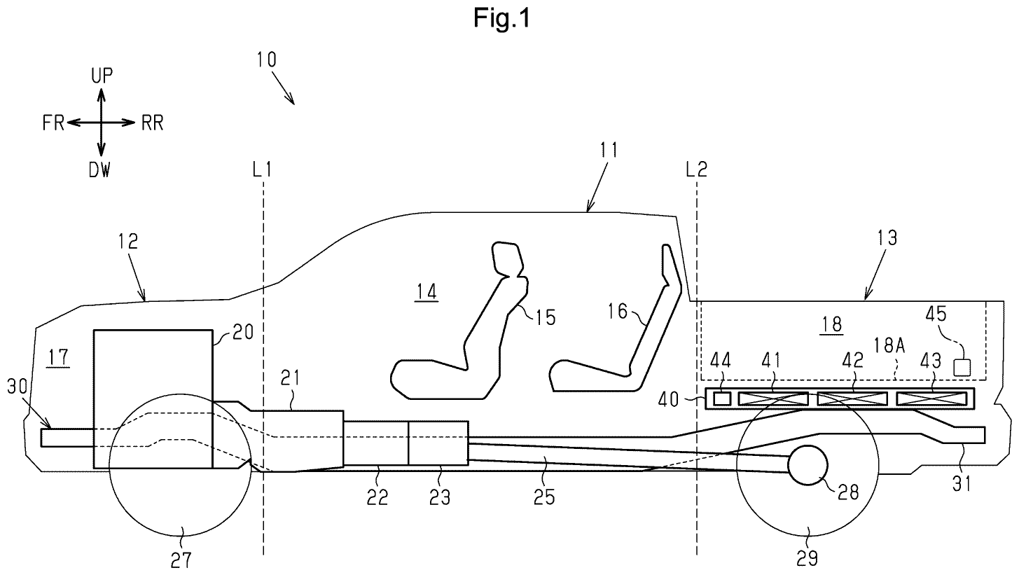

A pickup truck 10 according to a first embodiment will now be described with reference to FIGS. 1 to 4. Arrows shown in FIGS. 1 to 6 indicate direction in relation to the pickup truck 10. Specifically, FR indicates the forward direction, RR indicates the rearward direction, UP indicates the upward direction, DW indicates the downward direction, LF indicates the leftward direction, and RF indicates the rightward direction. The pickup truck 10 of the present embodiment is configured as a PHEV.

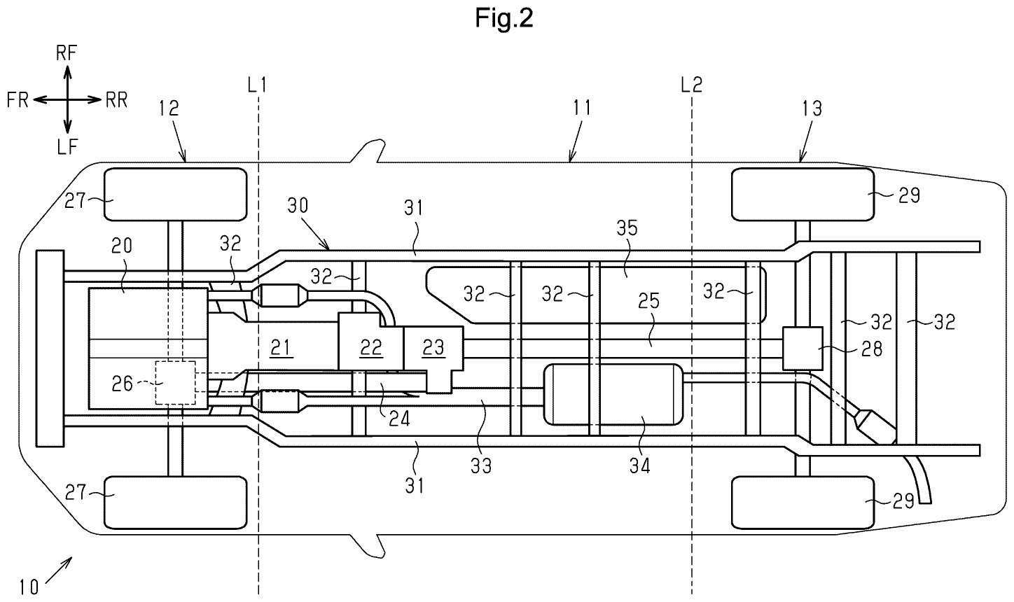

As shown in FIG. 1, the pickup truck 10 includes three sections, i.e., a cabin section 11, an engine compartment section 12 forward (FR) of the cabin section 11, and a cargo section 13 rearward (RR) of the cabin section 11. The cabin section 11 is provided with a passenger compartment 14, which accommodates occupants. A front-row seat 15 and a rear-row seat 16, which is positioned rearward (RR) of the front-row seat 15, are installed in the passenger compartment 14. The engine compartment section 12 includes an engine compartment 17 in which the engine 20 is arranged longitudinally. An engine 20 having a V-type cylinder arrangement is mounted on the pickup truck 10 of the present embodiment. The cargo section 13 includes a truck bed 18 that opens upward (UP). In FIGS. 1 and 2, the boundary between the cabin section 11 and the engine compartment section 12 is indicated by dotted line L1. In FIGS. 1 to 4, the boundary between the cabin section 11 and the cargo section 13 is indicated by dotted line L2.

### Configuration of the Drivetrain of the Pickup Truck

Next, the configuration of the drive system of the pickup truck 10 will be described with reference to FIG. 2. The drivetrain of the pickup truck 10 includes an engine 20, a transmission 21, a motor 22, and a transfer case 23. The motor 22 is configured both to generate rotational driving force for driving the pickup truck 10 in response to supplied electric power and to generate electric power by receiving rotational input from the engine 20 or from the wheels. The drivetrain of the pickup truck 10 includes propeller shafts 24 and 25 for front wheels 27 and rear wheels 29. The propeller shafts 24 and 25 are each connected to the engine 20 via the transfer case 23, the motor 22, and the transmission 21. The propeller shaft 24 for the front wheels 27 is connected to the left and right front wheels 27 via a differential 26. The propeller shaft 25 for the rear wheels 29 is connected to the left and right rear wheels 29 via a differential 28. The propeller shaft 25 for the rear wheels 29 is configured to guide rotational driving force of the engine 20 and the motor 22 to the rear wheels 29.

### Configuration of Underfloor Structure of the Pickup Truck

The configuration of the underfloor structure of the pickup truck 10 will now be described with reference to FIG. 2. The space under the floor of the pickup truck 10 refers to a region below (DW) floor panels 14A and 18A of the passenger compartment 14 and the truck bed 18 (see FIG. 6).

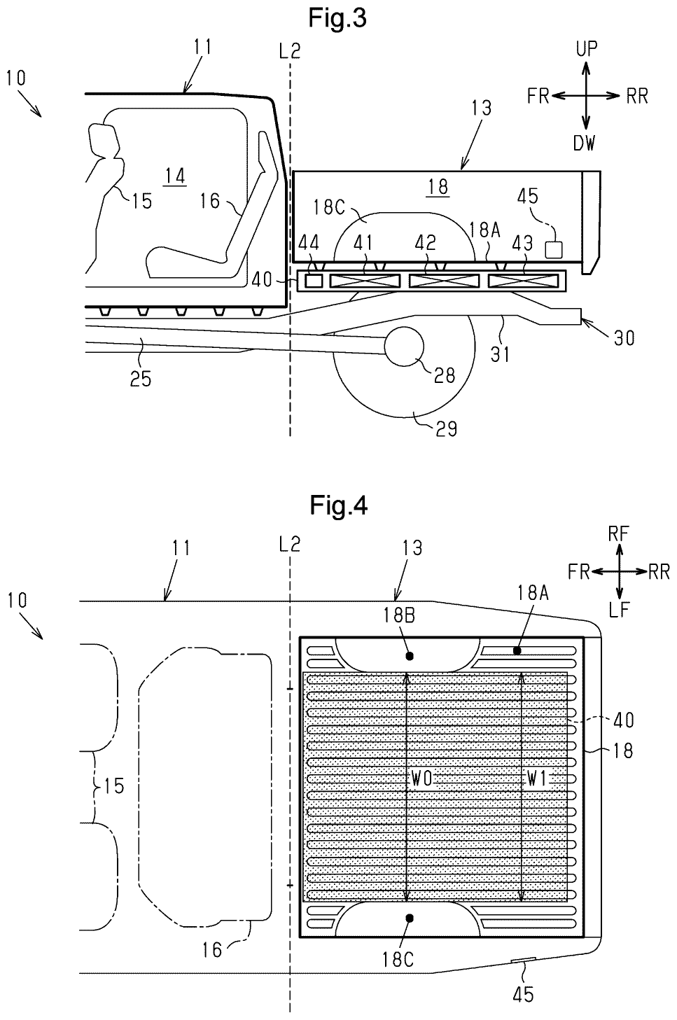

A frame 30 is provided under the floor of the passenger compartment 14 and the truck bed 18 of the pickup truck 10. The frame 30 of the pickup truck 10 of the present embodiment is a ladder-type frame having left and right side members 31 and multiple cross members 32 connecting the side members 31. The left and right side members 31 are each disposed so as to extend in the vehicle longitudinal direction through a region in the cabin section 11 that is below (DW) the passenger compartment 14. As shown in FIG. 3, the propeller shaft 25 for the rear wheel 29 extends in the vehicle longitudinal direction through the region in the cabin section 11 that is below (DW) the passenger compartment 14.

Further, an exhaust pipe 33 that guides exhaust gas of the engine 20 rearward (RR) is disposed under the floor of the pickup truck 10. The exhaust pipe 33 extends in the vehicle longitudinal direction through the region in the cabin section 11 that is below (DW) the passenger compartment 14. A muffler 34 is installed at an intermediate portion of the exhaust pipe 33. The muffler 34 is disposed in the region in the cabin section 11 that is below (DW) the passenger compartment 14. Further, a fuel tank 35 for storing fuel for the engine 20 is installed under the floor of the pickup truck 10. The propeller shaft 25 for the rear wheels 29 is disposed in a region between the exhaust pipe 33 and the fuel tank 35 in the vehicle width direction.

As shown in FIG. 4, a floor panel 18A of the truck bed 18 has a corrugated shape. Left and right wheel housings 18B, 18C for accommodating left and right rear wheels 29 are provided on the left and right sides of the truck bed 18, respectively.

### Arrangement of Main Battery 40

The pickup truck 10 is provided with a main battery 40 used as a power source for the motor 22. Next, the arrangement of the main battery 40 of the pickup truck 10 will be described with reference to FIGS. 3 and 4. In the present embodiment, the main battery 40 is the sole battery used as the power source for the motor 22. The pickup truck 10 may include, for example, an auxiliary battery inside the engine compartment 17. The auxiliary battery supplies electric power of a voltage lower than that of the main battery 40 to vehicle on-board electric devices other than the motor 22.

As shown in FIG. 3, the main battery 40 is installed in a region in the cargo section 13 that is below (DW) the floor panel 18A of the truck bed 18 and above (UP) the frame 30. The outer shape of the main battery 40 is a rectangular parallelepiped shape. As shown in FIG. 4, a dimension W1 of the main battery 40 in the vehicle width direction is substantially equal to a distance W0 between the left and right wheel housings 18B. In the present embodiment, the main battery 40 is fixed to the frame 30.

The main battery 40 includes three modules 41 to 43 arranged in the vehicle longitudinal direction and a high-voltage electrical unit 44, all integrally configured. Each of the modules 41 to 43 is a battery pack composed of multiple cells (unit batteries). In the present embodiment, the cells constituting each of the modules 41 to 43 are arranged in the vehicle width direction. The high-voltage electrical unit 44 is a vehicle on-board electric device configured to perform power conversion or power distribution. Examples of the high-voltage electrical unit 44 include a power control unit, a charging control unit, a step-down unit, and a junction box. The power control unit is an electrical unit that performs power control of the motor 22. The charging control unit is an electrical unit configured to control charging of the main battery 40. The step-down unit is an electrical unit configured to convert high-voltage power output from the main battery 40 into low-voltage power to be supplied to vehicle on-board electric devices other than the motor 22. The junction box is an electrical unit having a function as a distribution board. The high-voltage electrical unit 44 may be configured to have functions of multiple electrical units. In the present embodiment, the high-voltage electrical unit 44 is disposed forward (FR) of the modules 41 to 43 of the main battery 40.

A charging port 45 for externally charging the main battery 40 is provided in a rear region (RR) in the cargo section 13. The charging port 45 houses a connector configured to connect to a charging cable from a charging station or the like. In the case of FIG. 4, the charging port 45 is provided in a left region (LF) in the cargo section 13 that is rearward (RR) of the wheel housing 18C.

### Operation of the First Embodiment

In addition to the frame 30, components such as the propeller shaft 25, the exhaust pipe 33, and the fuel tank 35 are installed under the floor of the pickup truck 10, which is configured as a PHEV. Therefore, it is difficult to allocate sufficient mounting space beneath the floor of the pickup truck 10 for the main battery 40, which supplies power to the motor 22.

In the pickup truck 10 according to the present embodiment, the main battery 40 is installed in a region in the cargo section 13 that is below (DW) the floor panel 18A of the truck bed 18 and above (UP) the frame 30. This installation space for the main battery 40 is readily allocated by a simple reconfiguration, such as raising the position of the floor panel 18A of the truck bed 18.

### Aspects of the First Embodiment

The pickup truck 10 of the present embodiment configured as described above provides the following aspects.
(1) The pickup truck 10 of the present embodiment includes the main battery 40 as the power source for the motor 22. The main battery 40 is installed in the region in the cargo section 13 that is below (DW) the floor panel 18A of the truck bed 18. Therefore, even in the pickup truck 10, which is configured as a PHEV, it is possible to allocate a mounting space for the main battery 40, which has a large capacity.
(2) The dimension W1 of the main battery 40 in the vehicle width direction is less than the dimension of the floor panel 18A in the vehicle width direction, and is equal to the distance W0 between the left and right wheel housings 18B and 18C. Therefore, for example, the main battery 40 does not need to have a complicated shape so as to avoid interference with the rear wheels 29.
(3) The main battery 40 is fixed to the frame 30, which has high rigidity. Thus, when an impact is applied to the pickup truck 10 from the outside, the impact is unlikely to be applied to the main battery 40.
(4) The charging port 45 is provided in the rear region (RR) in the cargo section 13. Since the distance between the charging port 45 and the main battery 40 is relatively short, routing of the wiring between the charging port 45 and the main battery 40 is facilitated. In addition, since the charging port 45 is provided in the rear region (RR) of the pickup truck 10, charging at a charging station or the like is facilitated even when the charging cable is relatively short.
(5) In the region between the left and right side members 31 of the cargo section 13, components such as the propeller shaft 25, the exhaust pipe 33, and the fuel tank 35 are installed, making it difficult to provide installation space for the main battery 40. In the pickup truck 10 according to the present embodiment, the main battery 40 is installed in the region in the cargo section 13 that is below (DW) the floor panel 18A of the truck bed 18 and above (UP) the frame 30. This allows the large-capacity main battery 40 to be installed in the region that is below (DW) the floor panel 18A of the truck bed 18.

### Second Embodiment

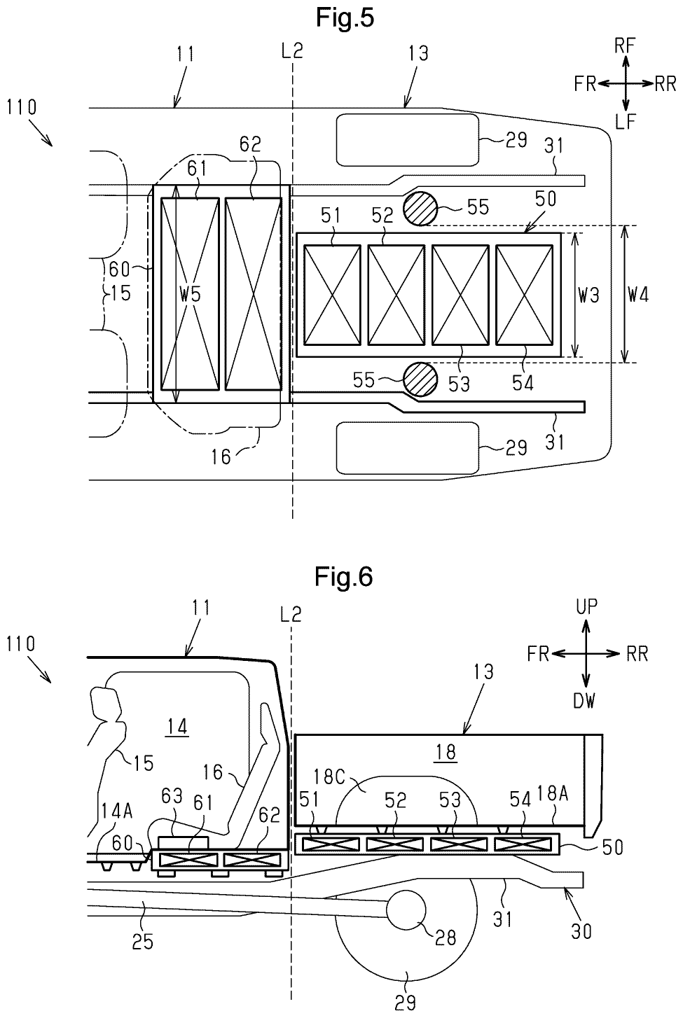

A pickup truck 110 according to a second embodiment will now be described with reference to FIGS. 5 and 6. The same reference numerals are given to those components in the present embodiment that are the same as the corresponding components of the first embodiment. Such components will not be described in detail. The present embodiment is different from the first embodiment in the configuration and arrangement of main batteries. The pickup truck 110 of the present embodiment includes a first main battery 50 and a second main battery 60 as main batteries used as power sources for the motor 22.

Similarly to the main battery 40 of the first embodiment, the first main battery 50 is installed in the region in the cargo section 13 that is below (DW) the floor panel 18A of the truck bed 18 and above (UP) the frame 30. The first main battery 50 includes four modules 51 to 54 arranged in the vehicle longitudinal direction, and has a rectangular parallelepiped shape. As shown in FIG. 5, left and right suspension struts 55 for suspending the left and right rear wheels 29 are disposed under the floor of the cargo section 13. A dimension W3 of the first main battery 50 in the vehicle width direction is less than or equal to a distance W4 between the struts 55. The first main battery 50 is fixed to the frame 30.

On the other hand, the second main battery 60, which is another main battery used as a power source for the motor 22, is installed in the region in the cabin section 11 that is below (DW) the rear-row seat 16 and above (UP) the frame 30. In the present embodiment, the second main battery 60 is disposed outside the passenger compartment 14, specifically, in the region in the cabin section 11 that is below (DW) the floor panel 14A of the passenger compartment 14. The front end (FR) of the second main battery 60 is rearward (RR) of the front end (FR) of the rear-row seat 16. The second main battery 60 includes two modules 61, 62 disposed in the vehicle longitudinal direction, and a high-voltage electrical unit 63 disposed above (UP) the modules 61, 62. A dimension W5 of the second main battery 60 in the vehicle width direction is greater than the dimension W3 of the first main battery 50 in the vehicle width direction, around which the struts 55 exist. Further, the second main battery 60 is disposed such that the position thereof in the vehicle height direction is the same as the position of the first main battery 50 in the vehicle height direction.

### Aspects of the Second Embodiment

The pickup truck 110 of the present embodiment configured as described above provides the following aspects.
(1) The main battery used as the power source for the motor 22 is divided and disposed in two regions. One of the two regions is the region in the cargo section 13 that is below (DW) the floor panel 18A of the truck bed 18. The other region is the region in the cabin section 11 that is below (DW) the rear-row seat 16 and above (UP) the frame 30. As a result, the individual sizes of the first main battery 50 and the second main battery 60, which are disposed in the respective regions, are smaller than the size of a single battery having a combined total capacity. Accordingly, the pickup truck 110 according to the present embodiment facilitates installation of high-capacity main batteries used as the power sources for the motor 22.
(2) The first main battery 50 is installed in the region in the cargo section 13 that is below (DW) the floor panel 18A of the loading truck bed 18. Therefore, the first main battery 50 can be installed in the cargo section 13 while minimizing reduction in the load capacity of the truck bed 18.
(3) The dimension W3 of the first main battery 50 in the vehicle width direction is less than or equal to the distance W4 between the struts 55. Therefore, the first main battery 50 does not need to have a complicated shape so as to avoid interference with the struts 55.
(4) The first main battery 50 is fixed to the frame 30, which has high rigidity. Thus, when an impact is applied to the pickup truck 10 from the outside, the impact is unlikely to be applied to the first main battery 50.
(5) The second main battery 60 is installed in the region in the cabin section 11 that is below (DW) the rear-row seat 16 and above (UP) the frame 30. Therefore, it is possible to install the second main battery 60 in the cabin section 11 while minimizing reduction in the occupant space of the passenger compartment 14.
(6) The front end (FR) of the second main battery 60 is rearward (RR) of the front end (FR) of the rear-row seat 16. As a result, installation of the second main battery 60 does not significantly reduce the legroom available to an occupant seated in the rear-row seat 16.
(7) The position of the second main battery 60 in the vehicle height direction is the same as the position of the first main battery 50 in the vehicle height direction. This configuration facilitates routing of harnesses, bus bars, and the like for electrically connecting the first main battery 50 to the second main battery 60.
(8) The second main battery 60 is installed outside the passenger compartment 14. This configuration provides greater isolation between the occupants and the second main battery 60 than a configuration in which the second main battery 60 is installed inside the passenger compartment 14.
(9) The first main battery 50 is installed in the region in the cargo section 13 that is below (DW) the floor panel 18A of the truck bed 18 and above (UP) the frame 30. This allows the large-capacity first main battery 50 to be installed in the region that is below (DW) the floor panel 18A of the truck bed 18.

### Other Embodiments

The above-described embodiments may be modified as follows. The above-described embodiments and the following modifications can be combined as long as the combined modifications remain technically consistent with each other.

In the pickup truck 10 of the first embodiment, the position of the charging port 45 may be changed.

In the pickup truck 10 of the first embodiment, the dimension W1 of the main battery 40 in the vehicle width direction is equal to the distance W0 between the left and right wheel housings 18C. The dimension W1 of the main battery 40 in the vehicle width direction may be changed as long as interference with other members is avoided. In order to avoid interference with the rear wheels 29, it is desirable that the dimension W1 of the main battery 40 in the vehicle width direction be less than or equal to the distance W0 of the wheel housing 18C.

In the pickup truck 110 of the second embodiment, the high-voltage electrical unit 63 may be provided in the first main battery 50.

The high-voltage electrical unit 44 may be provided separately from the main battery 40. Similarly, the high-voltage electrical unit 63 may be provided separately from both the first main battery 50 and the second main battery 60.

The main battery 40 and the first main battery 50 may be fixed to a member other than the frame 30, for example, the floor panel 18A of the truck bed 18.

In the above-described embodiment, the main battery 40 and the first main battery 50 are installed in the region in the cargo section 13 that is below (DW) the floor panel 18A of the truck bed 18 and above (UP) the frame 30. The main battery 40 and the first main battery 50 may be installed in a region below (DW) the positions in the embodiments, for example, in a region between the left and right side members 31.

The floor panel 18A of the truck bed 18 does not necessarily need to have a corrugated shape.

The dimension W1 of the main battery 40 in the vehicle width direction may be greater than the distance W0 between the left and right wheel housings 18B and 18C. Even in this case, interference between the wheel housings 18B, 18C and the main battery 40 can be avoided by configuring the main battery 40 such that only the regions corresponding to the vicinity of the wheel housings 18B, 18C have a reduced width in the vehicle width direction relative to the distance W0.

The dimension W3 of the first main battery 50 in the vehicle width direction may be greater than the distance W4 between the struts 55. Even in this case, interference between the struts 55 and the first main battery 50 can be avoided by configuring the first main battery 50 such that only the regions corresponding to the vicinity of the struts 55 have a reduced width in the vehicle width direction.

As the engine 20, an engine having a cylinder arrangement other than the V type may be employed. Additionally, the engine 20 may be transversely mounted within the engine compartment 17.

The arrangement of components such as the propeller shaft 25, the exhaust pipe 33, the muffler 34, and the fuel tank 35 under the floor of the pickup truck 10, 110 may be changed. For example, the pickup truck 10, 110 may be configured such that the propeller shaft 25 is disposed between the exhaust pipe 33 and the fuel tank 35 in the vehicle width direction.

The configuration of the drivetrain of the pickup truck 10, 110 can be changed. For example, the drivetrain may be configured to drive the front wheels 27 and the rear wheels 29 via separate, independent drive systems, or may be configured as a front-wheel drive vehicle.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A pickup truck configured as a plug-in hybrid electric vehicle, comprising:
a fuel tank;
an engine;
a motor;
a transmission;
a propeller shaft connected to the engine via the motor and the transmission and configured to transmit rotational driving force of the engine and the motor to a rear wheel;
an exhaust pipe that guides exhaust gas of the engine rearward in the vehicle;
a cabin section provided with a passenger compartment;
an engine compartment section forward of the cabin section;
a cargo section rearward of the cabin section; and
a frame including left and right side members that extend in a vehicle longitudinal direction through a region in the cabin section that is below the passenger compartment, wherein
the engine compartment section includes an engine compartment in which the engine is arranged longitudinally, and
the cargo section includes a truck bed that opens upward,
the propeller shaft and the exhaust pipe extend in the vehicle longitudinal direction through the region in the cabin section that is below the passenger compartment, and
the pickup truck further comprises a main battery as a power source for the motor, the main battery being installed in a region in the cargo section that is below a floor panel of the truck bed.

2. The pickup truck according to claim 1, wherein a dimension of the main battery in a vehicle width direction is less than a dimension of the floor panel in the vehicle width direction.

3. The pickup truck according to claim 1, wherein
the rear wheel is one of left and right rear wheels,
the cargo section includes left and right wheel housings that respectively house the left and right rear wheels, and
a dimension of the main battery in a vehicle width direction is less than or equal to a distance between the left and right wheel housings.

4. The pickup truck according to claim 1, wherein
the rear wheel is one of left and right rear wheels, and
a dimension of the main battery in a vehicle width direction is less than or equal to a distance between struts of left and right suspensions that suspend the left and right rear wheels, respectively.

5. The pickup truck according to claim 1, wherein the main battery is fixed to the frame.

6. The pickup truck according to claim 1, wherein the floor panel has a corrugated shape.

7. The pickup truck according to claim 1, wherein a charging port for externally charging the main battery is provided in a rear region in the cargo section.

8. The pickup truck according to claim 1, wherein
a front-row seat and a rear-row seat that is disposed rearward of the front-row seat are installed in the passenger compartment, and
in addition to the main battery, another main battery used as a power source for the motor is installed in a region in the cabin section that below the rear-row seat.

9. The pickup truck according to claim 1, wherein the main battery is a sole battery in the pickup truck that is used as a power source for the motor.

10. The pickup truck according to claim 1, wherein the main battery is installed in a region in the cargo section that is above the frame.
